(19) United States
(12) Patent Application Publication
(10) Pub. No.: US 2004/0128222 A1
(43) Pub. Date: Jul. 1, 2004

(54) Risk measurement, management and trade decisioning system

(76) Inventors: Wallace C. Turbeville, New York, NY (US); J. Scott Perry, New York, NY (US)

Correspondence Address: Peter D. Aufrichtig, Esq., AUFRICHTIG STEIN & AUFRICHTIG, P.C., 5th Floor, 300 East 42nd Street, New York, NY, 10017, US

(21) Appl. No.: 10/647,101

(22) Filed: Aug. 22, 2003

Related U.S. Application Data
(60) Provisional application No. 60/405,607, filed on Aug. 23, 2002.
(60) Provisional application No. 60/407,070, filed on Aug. 30, 2002.

(51) Int. Cl. G06F 17/60

(52) U.S. Cl. 705/37

(57) ABSTRACT

A method of determining whether to allow a new trade of a contract in a system which determines the value of margin amounts supporting trading and evaluates the total value at risk in a portfolio of traded contracts. The system compares the value at risk in the portfolio to the value of margin amounts to calculate the excess available margin. After calculating the allowable notional trade volume, allowable notional trade quantity and the risk per unit of commodity for a new trade it determines whether the new trade has a value at risk which exceeds the excess available margin. It then approves or rejects the trade based upon a determination of whether the value at risk of the new trade exceeds the excess available margin. It also includes a second chance mechanism for rejected trades if the effect of the trade would be to increase the excess available margin of the portfolio.

### This application claims the priority of prior provisional application 60/405,607 filed on Aug. 23, 2002 and 60/407,070 filed on Aug. 30, 2002.

### BACKGROUND OF THE INVENTION

The invention is generally directed to a method of measuring a specified level of risk between contracting counterparties and related to specific contracts, and using this measure in a further method of measuring net exposures between contracting counterparties to determine whether to take on the additional risk of an additional contract. In particular, the system is particularly useful in determining the risk associated with a trade and then evaluating whether the additional risk to be added to a portfolio of contracts from prior trades maintains the overall risk exposure of the portfolio within the limits set on risk exposures a counterparty may take with respect to another contract counterparty. The methods can support trading systems which operate in markets, and can be applied to markets which are either one-to-many or many-to-many type markets.

Traditionally, trading firms place limits on the size of trades they will allow to be executed with other firms based on the financial exposure they would face in the event their counterparty were to default prior to delivery and/or settlement of their contract with such counterparty. Such limits are generally set to be a dollar volume limit, applicable to a particular trade, and are reset periodically by the counterparties based on periodical review of the net positions between the parties and any changes in credit quality. This system is inefficient and both unnecessarily hampers traders from making trades that could be made without violating relevant limits and allowing trades which take the trader's aggregate position outside of the relevant limits.

The filter process is especially important in the trading of less liquid commodities and financial products, as it is important to measure and cover the possible market moves which may be incurred if a counterparty were to default.

As an example, an electricity trading firm purchasing power for delivery one year forward. One risk that that it's counterparty defaults prior to delivery and power prices have increased. This risk can be mitigated by the seller posting margin for the amount of increase in power price above the contract price. An additional risk is that markets move between the time of a default and the time a buyer covers the defaulted position. This risk, commonly referred to as Value At Risk (or VAR) exists for both sides of the trade. If the buyer defaulted after power prices nominally had risen (ie—the seller had posted sufficient collateral based on a market index to cover the gap between the contract price and the market price), a seller could still incur a loss if the actual replacement value of the power were lower than the original contract price.

Accordingly, there is a need for a unique method of measuring the VAR for a given trade, and comparing this VAR amount to limits set by a counterparty and a method of utilizing this comparison in deciding whether or not to enter into the subject trade with the counterparty.

### SUMMARY OF THE INVENTION

The invention is generally directed to a method of establishing the risk associated with a potential trade, based on calculations from market indices and other sources and then evaluating, based on a trading entity's portfolio and credit limit whether the trade can be completed without causing the risk associated with the trading entity's portfolio to exceed its credit limit.

The invention is also directed to a method of establishing the risk associated with a potential trade, based on calculations from market indices and other sources and then evaluating, based on a trading entity's portfolio and credit limit whether the trade can be completed without causing the risk associated with the trading entity's portfolio to exceed its credit limit, performing a second evaluation of the trade's suitability if the trade would have increased the risk beyond the credit limit if the consummation of the trade would have the effect of increasing the available credit limit.

The invention is also directed to a method of evaluating and establishing the degree of risk associated with a particular trade based on market indices and establishment of risk containment policies which limit the various risks associated with counterparty trading.

Another object of the invention is to provide an improved system for enhancing controls on market trading in futures markets so that credit limits for different products can be integrated into a single credit limit system and each trade of a single product is evaluated against the portfolio's risk level prior to the trade.

Still a further object of the invention is to provide an improved method of determining whether a trade would cause a portfolio to exceed the risk limit of a trader's credit by calculating and netting the proposed trade with the existing portfolio in a fashion which considers the effect of potential netting by the proposed trade with other positions in the trader's portfolio.

Yet another object of the invention is to provide an improved market trading risk control system which establishes values for different variables associated with the credit risk limit and portfolio and proposed trade and applies filtering algorithms to such values to determine whether to allow a trade to proceed.

Still another object of the invention is to provide a credit filter process utilizing a pre-specified value at risk (“VAR”) calculation based on previously obtained price indices.

Still other objects and advantages of the invention will, in part be obvious, and will in part be apparent from the specification.

The invention accordingly comprises the features of construction, combination of elements, arrangement of parts, combinations of steps and procedures, all of which will be exemplified in the constructions and processes hereinafter set forth and the scope of the invention will be indicated in the claims.

### BRIEF DESCRIPTION OF THE DRAWINGS

For a fuller understanding of the invention, reference is had to the following descriptions taken in connection with the accompanying drawings, in which:

FIG. 1 is a flow chart diagram of the processes involved in the system and methods in accordance with a preferred embodiment of the invention.

### DETAILED DESCRIPTION OF THE PREFERRED EMBODIMENTS

The methods in accordance with the invention differ substantially from other processes available in the commodities and financial markets. Conventional clearinghouses operate through clearing members, and each clearing member operates with its own trading clients. Under this structure, clearing members must provide initial margins upon entering into trades, generally established as a fixed value or a percentage of the value of the trade based on the contract price. Trading firms also implement filters based on a per trade fixed risk calculation or a calculation based on the actual dollar volume of the trade, again, based on the contract price. The methods in accordance with the invention are directed to a credit filter process utilizing a pre-specified VAR calculation based on previously obtained price indices.

In accordance with the invention a system, called the VMAC Counterparty Credit Risk system, or VMAC, provides credit hedges to counterparties to traders of commodities. The hedges are offered in the form of commodity swaps settled daily against an indexed value. Under each VMAC swap, VMAC has the right to terminate the swap by paying a termination payment in the amount designed to approximate the Value at Risk (VAR) of the terminated swap contract. If a VMAC swap counterparty were to default, VMAC would act to limit its exposure in the commodity swap market; its maximum loss in covering a lost position is limited to the VAR amount VMAC could pay under its option to terminate a counterparty holding a swap with mirror terms. Therefore, VMAC requires collateral of each of its swap counterparties in the amount of the potential VAR option amount. This has the effect of reducing the VMAC system's exposure to trading risk to zero, because in the event of a default the VMAC system can terminate the paired swap for the termination amount, equal to the VAR amount, and it has collateral in that amount in hand from its counterparty to pay that amount.

A VMAC participant will provide collateral to VMAC in the amount of the net exposure VMAC has to the participant based on VMAC's net position with a participant. The netting process is undertaken periodically; the frequency of netting is dictated by availability of the marks to index and computing capacity. In a current preferred embodiment the market indices are updated daily and the netting process is updated on an half hour or hourly cycle. More frequent updates of the market data is possible only if the market index provider makes its index available more frequently. More frequent or less frequent updating of the netting process can be done if required by commercial activities.

VMAC has developed an system to provide credit limits on notional contract volumes and/or product quantities for contracts it will cover with its credit hedge system between clearing periods of the credit assurance system. This methodology can be applied to any system of contracting between counterparties, be it over an exchange or counterparty to counterparty:

Inputs for algorithm:

1. Limits on available margin: The VMAC Risk Measurement and Trade Decisioning System calculates an amount of acceptable risk at the end of each clearing run (LMT_{T}^{p,t}) for each VMAC participant, p (where clearing runs occur at time periods T=a,b,c,d . . . and trade coverage occurs serially between these times T, at times t=1,2,3,4 . . . ). This is based on available collateral or credit lines extended between counterparties.

2. Liquidity Coverage Amounts (LC): The VMAC System also calculates the termination amount, or the potential VAR associated with any particular contract (“LC” amounts), which might be entered into by a counterparty and which is approved by VMAC; the LC amount can be represented as a percentage of the index value per commodity unit. This LC is calculated for each product i,ii,iii . . . at each interval T=a,b,c,d . . . ; therefore after each clearing run, the system provides LC for each product in the amount LC_{T}^{i . . .} For a contract for product i to be approved by the VMAC system between clearing periods, LC_{T}ⁱ must be less than LMT_{T}^{t}. In other words, the liquidity coverage amount of the total portfolio after any trade must not exceed the limit on available margin.

3. Net Product Quantity (Q): The VMAC System also calculates a net quantity for each product i,ii,iii . . . held in a participant's portfolio, at each interval T=a,b,c,d . . . ; therefore at the end of each clearing run, the system provides the net quantity of a product in the amount Q_{T}^{p,i . . .} .

4. Price Indexes (Pₐⁱ): The VMAC system utilizes price indexes which are updated periodically at time intervals T=a,b,c,d . . . for each product i,ii,iii . . . . Therefore at the end of each clearing run, the system provides price indexes Pₐⁱ Generally, the price indexes are some price per unit value. For example, it might be a price per unit barrel of oil, or price per unit of electrical power. In current preferred embodiments of the invention the price indexes are provided by third party industry suppliers relied upon by all traders.

The values determined above are utilized in connection with the VMAC System which calculates the current status of the system and portfolio variables at the end of each clearing run so that the next time period can proceed with updated values. Only some of the variables are updated and netted during a time period, but all of the values and variables are updated during the end of a time period in a clearing run. The manner and method of performing these steps is described below. First, the way in which the Clearing process operates to update the LMT, LC and Q values. Next, the ways in which the determination of whether to accept or permit a trade to go forward, and a second chance if the trade is initially rejected. Finally, at the end of another trading period, the values for LMT, LC and Q are updated to take into account netting and aggregation of all trades and contracts in the portfolio. And the system repeats.

A. Clearing Output: At the end of each clearing run [a], the system calculates LMTₐ^{p,0}, LCₐⁱ and Qₐ^{p,i,0} for products i,ii,iii . . . , utilizing all trades of the participant and the updated prices Pₐⁱ for products i,ii,iii . . . available during run [a]. Qₐ^{p,i,0}<0 indicates a net short position, Qₐ^{p,i,0}>0 indicates a net long position.

a. At t=0, the allowable notional trade volume for a new trade for any product i for participant p is then calculated as:

i. NOTVOLLMTₐ^{p,i,0}=LMTₐ^{p,0}/(LCₐⁱ);

b. At t=0, the allowable notional trade quantity for a new trade for any product i for participant p is then calculated as:

i. NOTQLMTₐ^{p,i,0}=LMTₐ^{p,0}/(LCₐⁱ*Pₐⁱ);

c. At t=0, the risk per unit of commodity for a new trade for any product i is also calculated as:

i. (LCₐⁱ*Pₐⁱ)

d. NOTQLMTₐ^{p,i,0}, NOTVOLLMTₐ^{p,i,0}, Qₐ^{p,i,0} and (LCₐⁱ*Pₐⁱ) are provided as inputs to a VMAC trade permissioning filter;

B. Trade Input: A trade is attempted and the VMAC filtering process is initiated;

a. The filter can calculate applicable risk allocation for the contemplated trade based on the price index Pₐⁱ, in several different methods, allowing flexibility to the user. In practice only one of the different methods would be used, since they provide equivalent filtering and would provide the same result. The different approaches allow a user to adapt the filtering process to the way in whey they look at trades so that the results are more intuitive to the user. However, they each perform the same basic evaluation which is intended to determine whether a proposed trade would raise the risk in the portfolio above the credit limit;

i. In method I. the system compares the absolute quantity of the trade Q^{i,1} of the trade (1), to NOTQLMTₐ^{p,i,0};

1. If ABS(Q^{i,1}) is less than or equal to NOTQLMTₐ^{p,i,0},

a. then the trade is allowed and is VMAC system covered, trade data is passed to the VMAC database; and the following adjustments are made to the above defined variables;

i. Qₐ^{p,i,1}=Qₐ^{p,i,0}+Q^{i,1}

ii. LMTₐ^{p,1}=LMTₐ^{p,0}−(ABS(Q^{i,1})*(LCₐⁱ*Pₐⁱ));

iii. NOTVOLLMTₐ^{p,i,1}=LMTₐ^{p,1}/(LCₐⁱ); and

iv. NOTQLMTₐ^{p,i,1}=LMTₐ^{p,1}/(LCₐⁱ*Pₐⁱ);

2. Else trade is disallowed;

ii. In method II. the system compares the monetary value of the proposed trade based on the Price Index, Pₐⁱ and the proposed quantity of the Q^{i,1} of the trade (1), to NOTVOLLMTₐ^{p,i,0};

1. If (Pₐⁱ*Q^{i,1}) is less than or equal to NOTVOLLMTₐ^{p,i,0},

a. then the trade is allowed and is VMAC system covered, trade data is passed to the VMAC database; and the following adjustments are made to above defined variables;

i. Qₐ^{p,i,1}=Qₐ^{p,i,0}+Q^{i,1}

ii. LMTₐ^{p,1}=LMTₐ^{p,0}−(ABS(Q^{i,1})*(LCₐⁱ*Pₐⁱ));

iii. NOTVOLLMTₐ^{p,i,1}=LMTₐ^{p,1}/(LCₐⁱ); and

iv. NOTQLMTₐ^{p,i,1}=LMTₐ^{p,1}/(LCₐⁱ*Pₐⁱ);

2. Else Trade is disallowed;

iii. In method III. the system compares the monetary value of the risk associated with a unit of commodity traded (LCₐⁱ*Pₐⁱ) with the available margin LMTₐ^{p,i,0} of the participant;

1. If (LCₐⁱ*Pₐⁱ) is less than or equal to LMTₐ^{p,i,0},

a. then the trade is allowed and is VMAC system covered, trade data is passed to the VMAC database; the following adjustments are made to above defined variables;

i. Qₐ^{p,i,1}=Qₐ^{p,i,0}+Q^{i,1}

ii. LMTₐ^{p,1}=LMTₐ^{p,0}−(ABS(Q^{i,1})*(LCₐⁱ*Pₐⁱ));

iii. NOTVOLLMTₐ^{p,i,1}=LMTₐ^{p,1}/(LCₐⁱ); and

iv. NOTQLMTₐ^{p,i,1}=LMTₐ^{p,1}/(LCₐⁱ*Pₐⁱ);

2. Else trade is disallowed;

C. If trades are disallowed, then

a. The potential trade (n) of product i, in quantity Qᵢⁿ would be analysed with regard to its impact on the existing portfolio of trades with a counterparty; if the trade (n) would increase the available risk limit LMTₐ^{p,1} due to increased netting in the portfolio with the proposed trade, then the appropriate comparison methodology I,II,or III above would be made using the increased LMTₐ^{p,1}; otherwise, the trade would be cancelled. This provides a second chance to see if a trade can be approved and is not necessary for the invention. The invention can be practiced with or without the second chance approach which provides a limited in period netting by allowing the credit limit to be changed if the effect of the trade on the portfolio would be to increase the credit limit.

D. Next Clearing Run at T=b: All trades which have been approved and sent to the VMAC database between time T=a and T=b are multilaterally netted with the VMAC participants' total portfolios and the following recalculations occur.

a. At t=0, the allowable notional trade volume for a new trade any product i for participant p is then calculated as:

i. NOTVOLLMT_{b}^{p,i,0}=LMT_{b}^{p,0}/(LC_{b}ⁱ);

b. At t=0, the allowable notional trade quantity for a new trade for any product i for participant p is then calculated as:

i. NOTQLMT_{b}^{p,i,0}=LMT_{b}^{p,0}/(LC_{b}ⁱ*P_{b}ⁱ);

c. At t=0, the risk per unit of commodity for a new trade for any product i is also calculated as:

i. (LC_{b}ⁱ*P_{b}ⁱ)

d. NOTQLMT_{b}^{p,i,0}, NOTVOLLMT_{b}^{p,i,0}, Q_{b}^{p,i,0} and (LC_{b}ⁱ*P_{b}ⁱ) are provided as inputs to a VMAC trade permissioning filter;

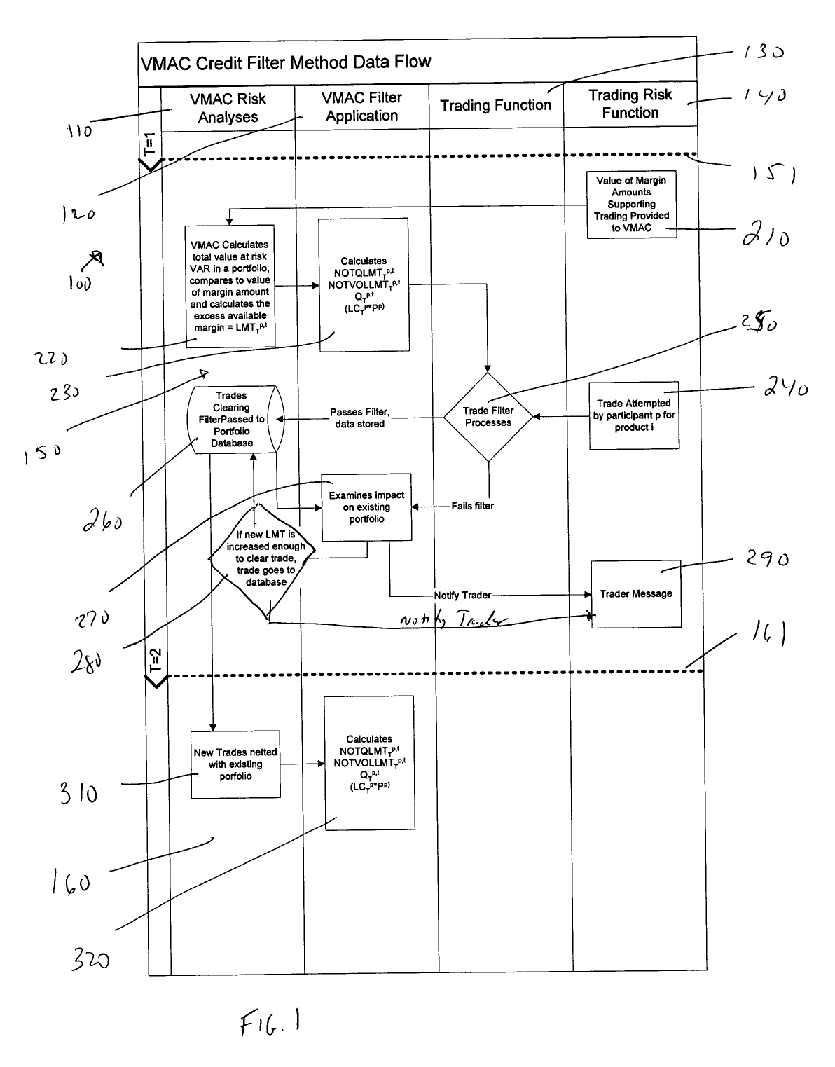

Reference is made to FIG. 1 wherein a flow chart diagram of the VMAC system in accordance with a preferred embodiment of the invention is depicted. The VMAC system, generally indicated as 100 includes four sectors or types of activities, VMAC Risk Analyses 110, VMAC Filter Application 120, Trading Function 130 and Trading Risk Function 140. The various process steps and procedures are located within the columns formed by these four sectors for ease of understanding. The beginning of time period T=1 is marked by dotted line 151 and the end of time period T=1 and beginning of time period T=2 is marked by dotted line 161. Activities between dotted lines 151 and 161 take place in time period T=1, those below line 161 take place in time period T=2. In practice there would be a series of time periods T=1,2,3 , . . . , but for purposes of description only one full period and a portion of the next one are shown for demonstration purposes.

In box 210 the value of the margin amounts supporting trading is provided to the VMAC system. Then, in box 220 the VMAC system calculates the total value at risk(VAR) in a portfolio and compares it to the value of margin amount and calculates the excess available margin LMT_{T}^{p,t}. Then, in box 230, in the Credit Filter Application Section the system calculates NOTQLMT, NOTVOLLMT and Q(LC). At this point with these values calculated, the trade filter processes are applied in decision box 250 when an attempted trade 240 is input. If the trade is passed through the filtering process, the trade is cleared and the data for the trade is passed to box 260 in which the data is added to the portfolio database. If the trade fails the filtering process in step 250, the VMAC Filter application in box 270 examines the impact of the proposed trade on the existing portfolio. If the effect does not increase the LMT, the Trader is notified in Box 290 that the trade has not been approved. If the effect of the trade would be to increase the LMT, in decision box 280 a determination is made whether there is enough LMT to clear the trade. If there is, the data is passed to box 260 as in above and the Trader notified that the trade was approved. If not, the trade is not passed and the Trader is notified that the trade has not been approved in Box 290. This cycle would repeat itself for each Trade attempted from box 240 during the time period T=1.

As time period T=1 ends and T=2 begins, in box 310 all the new trades made during the period T=1 are netted with the existing portfolio, and in box 320 new values for NOTQLMT, NOTVOLLMT and Q(LC) are calculated. Then the system operates as it did in the previous time period

Accordingly, an improved risk measurement, management and trade decisioning system in accordance with a preferred embodiment of the invention is provided. The system has the effect of providing the ability to handle a large number of products and trades without allowing any trades which exceed the credit limits of the trader. A matrix of different products are generally traded in the futures markets, where, for example each month's future delivery of oil is considered a different product(Gasoline July 2003 delivery, Gasoline August 2003 delivery, Gasoline September 2003 delivery, etc.). By evaluating and assigning VAR amounts for each product and each trade control of the credit limit can be maintained and managed efficiently without the need for managers to review each claim by traders and the traders need only propose a trade to determine whether such a trade would be allowed by the VMAC system.

It will thus be seen that the objects set forth above, among those made apparent in the proceeding description, are efficiently obtained and, since certain changes may be made in the above constructions and processes without departing from the spirit and scope of the invention, it is intended that all matter contained in the above description or shown in the accompanied drawings shall be interpreted as illustrative, and not in the limiting sense.

It will also be understood that the following Claims are intended to cover all of the generic and specific features of the invention, herein described and all statements of the scope of the invention which, as a matter of language, might be said to fall therebetween.

What is claimed is:

1. A method of determining whether to allow a new trade of a contract, comprising:
determining the value of margin amounts supporting trading;
evaluating the total value at risk in a portfolio of traded contracts;
comparing the value at risk in the portfolio to the value of margin amounts to calculate the excess available margin;
calculating the allowable notional trade volume, allowable notional trade quantity and the risk per unit of commodity for a new trade;
determining whether the new trade has a value at risk which exceeds the excess available margin;
approving the trade if it is determined that the value at risk of the new trade does not exceed the excess available margin; and
rejecting the trade if it is determined that the value at risk of the new trade exceeds the excess available margin.

2. The method of claim 1 wherein, further including reviewing any rejected new trade to see if the effect of the trade would have the effect of increasing the excess available margin and redetermining whether the new trade has a value at risk which exceeds the excess available margin as modified by the new trade, and approving or rejecting the trade based on that redetermination.

3. The method of claim 1 wherein the margin amounts are set by reviewing traditional credit information and establishing limits on risk.

4. The method of claim 1 wherein the new trades are considered for a period of time until the end of the period when a clearing is performed and the new trades approved and performed since the beginning of the period are netted with the portfolio to produce a new value at risk in the portfolio, value of margin and new values of allowable notional trade volume, allowable notional trade quantity and the risk per unit of commodity.

5. The method of claim 1 wherein the value at risk measurement is expressed on a per contract unit basis;

6. The method of claim 5 wherein the contract unit is expressed in units of a commodity.

7. The method of claim 5 wherein the contract unit is expressed in units of currency;

8. The method of claim 5 wherein the contract unit is expressed in units of time;

9. The method of claim 5 wherein the contract unit is expressed in a combination of units of time, currency and/or commodity;

10. The method of claim 1 wherein the value at risk measurement used is expressed as a percentage of an index value;

11. The method of claim 1 wherein the value at risk measurement used is expressed as a percentage of the contract value;

12. The method of claim 1 wherein different determinations of value at risk are made for specific products and contract terms;

13. The method of claim 1 wherein certain determinations of value at risk may cover many different products and/or contract terms;

14. The method of claim 1 wherein the value at risk determination is compared to the unit quantity of a proposed trade;

15. A method of claim 1 wherein the value at risk determination is compared to the dollar value of the proposed trade

16. A method of claim 1 wherein the value at risk determination is compared to the quantity of a proposed trade multiplied by an index value.
